(19) United States
(12) Patent Application Publication
(10) Pub. No.: US 2004/0141515 A1
(43) Pub. Date: Jul. 22, 2004

(54) Method of segmenting a re-ordering buffer of WCDMA HSDPA system and mapping data thereto

(76) Inventor: Zhi Yong Xiao, Singapore (SG)

Correspondence Address: QUARLES & BRADY LLP, 411 E. WISCONSIN AVENUE, SUITE 2040, MILWAUKEE, WI, 53202-4497, US

(21) Appl. No.: 10/731,363

(22) Filed: Dec. 9, 2003

(30) Foreign Application Priority Data
Dec. 10, 2002 (SG) 200207478-9

(51) Int. Cl. H04B 7/216; H04L 12/56

(52) U.S. Cl. 370/412; 370/335

(57) ABSTRACT

A method of segmenting a re-ordering buffer comprises: dividing the re-ordering buffer into multiple segments; dividing each segment into multiple blocks such that blocks within the same segment have the same size while the sizes of blocks located in separate segments are integer multiples of each other. A method of mapping TTI data to the re-ordering comprises: determining a size category of the TTI data; comparing the size category of the TTI data with sizes of the blocks of the segments to find a matching block for storing the TTI data; storing the TTI data in the matching block if an empty matching block is found, but if no empty matching block is found: storing the TTI data in a block with a size larger than the size category of the TTI data; storing the TTI data in adjacent blocks, if such a block with a larger size is unavailable.

### FIELD OF THE INVENTION

This invention relates to a method of segmenting a re-ordering buffer and mapping data thereto, and more particularly, but not exclusively, relates to a method of segmenting a re-ordering buffer in a WCDMA HSDPA system and mapping TTI data to the buffer.

### BACKGROUND OF THE INVENTION

HSDPA (High Speed Downlink Packet Access) is based on techniques such as adaptive modulation and hybrid ARQ (automatic repeat request) to achieve high throughput, reduce delay and achieve high peak rates. The new functionality of hybrid ARQ is involved in a MAC (Medium Access Control) layer which is just above a physical layer. The MAC layer is used to pass data received from the physical layer to an upper layer. A transport channel that the HSDPA functionality uses is called HS-DSCH (High Speed Downlink Shared Channel) and is controlled by the MAC-hs entity which is a part of MAC layer. There is only one MAC-hs entity in a UE (User Equipment).

The WCDMA HSDPA system uses a HARQ (hybrid automatic repeat request) entity to handle up to 8 HARQ processes for a UE, in which each process is independent and assigned an ID which represents one priority. Because of multi- and independent HARQ operation, it is possible to receive out-of-order TTI data in the downlink (UE side). Here, TTI data, i.e., transmission time interval data, is the data that the UE receives from the downlink within a prescribed transmission time interval. In a WCDMA HSDPA system, the above trasnmission time interval is 2 ms. However, the upper layer still must receive in-order TTI data, so there is a re-ordering entity in the MAC-hs to organize the out-of-order TTI data received from the HARQ entity and deliver the re-ordered data to the upper layer. The re-ordering entity in the MAC-hs includes a re-ordering buffer for buffering and organizing the out-of-order TTI data under control from a controller in the MAC-hs. Logically, the re-ordering buffer is comprised of up to 8 re-ordering sub-buffers (namely, 8 re-ordering queues) to handle the out-of-order TTI data from the 8 HARQ processes.

The re-ordering buffer in the HSDPA system needs to prepare up to 8 re-ordering queues to handle the out-of-order TTI data from the HARQ entity, where each queue contains up to 32 out-of-order TTI data. The maximum length of each TTI data is N bits, where N depends on which class a UE supports. For example, if the UE supports a 3.6 Mb/s class, the max TTI data size, N, equals 7300 bits and there is a total of 6 re-ordering queues in the reordering buffer.

In the prior art, two algorithms of memory allocation and disposal are widely used, namely, the static algorithm and the dynamic algorithm.

In the static algorithm, the memory is composed of multiple equally-sized blocks which are large enough to store received TTI data of any size, as specified in the specification 3GPP TS 25.308. Therefore, using the static algorithm, a re-ordering buffer needs to prepare as many blocks as the maximum number of the received out-of-order TTI data. For the above 3.6 Mb/s class, the buffer has to prepare 6×32 blocks, each of the size of 7300 bits. In other words, the total buffer size for the static algorithm soars to 6×32×7300 bits=1388.75 Kb. Unfortunately, it is not affordable for hardware implementation.

In the dynamic algorithm there are no blocks of pre-defined size in the memory, and each memory-allocation is based on the size of the TTI data which needs to be stored. More specifically, in the dynamic algorithm, there are no fixed size blocks in the buffer and the TTI data are stored in the buffer sequentially. A store address for each of the TTI data depends upon the address of the last stored TTI data. When the buffer releases one TTI data which is stored in the middle part of the buffer, all of the TTI data stored thereafter needs to be moved up so as to fill the obsolete space left by the released data. Theoretically, the above process is called Garbage Collection. It can be seen that although the dynamic algorithm can reduce the total buffer size, it requires huge processing time to do the garbage collection to reuse the obsolete space in the buffer.

Therefore, there is a need existing in the art to provide an efficient method of segmenting a re-ordering buffer in the WCDMA HSDPA system and to map TTI data thereto, which will not only reduce the necessary buffer size but save processing time. There are several difficulties in implementing such a re-ordering function. A simple algorithm for buffer segmentation and mapping reduces hardware complexity and consumes less hardware operation time, but it needs a large buffer size, which will increase the hardware cost. Alternatively, a complex algorithm requires a smaller buffer size, but at the cost of additional hardware complexity and slower hardware operation time. Thus, there is additionally a need for a method which will balance the hardware operation time, hardware complexity and total buffer size.

### SUMMARY OF THE INVENTION

In accordance with first aspect of the present invention, there is provided a method of segmenting a re-ordering buffer in WCDMA HSDPA system, comprising the steps of: dividing the re-ordering buffer into multiple segments; dividing each segment into multiple blocks such that blocks within the same segment have the same size while the sizes of blocks located in separate segments are integer multiples of each other.

Typically, the multiple segments include a first, second and third segment.

Typically, the size of the blocks of the first segment is 2 times that of the second segment, and 4 times that of the third segment.

Preferably, the size of the blocks of the first segment is the maximum length of received TTI data.

Preferably, the size of the blocks of the first segment is half of the maximum length of received TTI data.

In accordance with second aspect of the present invention, there is provided a re-ordering buffer for storing TTI data in WCDMA HSDPA system, comprising multiple segments, wherein each segment is composed of multiple blocks with equal size, and the sizes of the blocks of a first segment of the multiple segments are integer multiples of the sizes of the blocks of additional segments of the multiple segments.

In accordance with third aspect of the present invention, there is provided a method of mapping TTI data to the above re-ordering buffer, comprising the steps of: determining a size category of the TTI data; comparing the size category of the TTI data with sizes of the blocks of the first segment and the additional segments to find a matching block for storing the TTI data; storing the TTI data in the matching block if an empty matching block is found, but if no empty matching block is found then: storing the TTI data in a block with a size larger than the size category of the TTI data; storing the TTI data in adjacent blocks, if such a block with a larger size is unavailable.

Preferably, the step of determining is based on the size of the TTI data and the sizes of the blocks of the segments.

Preferably, the step of storing the TTI data in a block with a larger size comprises the steps of: If a larger sized block is partially occupied but still has enough space for the TTI data, storing the data in the block; and If such a larger sized block is unavailable, storing the TTI data in a free block with a larger size.

Preferably, the step of storing the TTI data in adjacent blocks comprises a step of storing the TTI data in a minimum number of adjacent blocks.

### BRIEF DESCRIPTION OF THE DRAWINGS

Embodiments of the invention will now be described, by way of example, with reference to the accompanying drawings, in which:

FIG. 1 schematically illustrates a segmentation structure of a re-ordering buffer at 3.6 Mb/s UE class according to a first embodiment of the present invention; and

FIG. 2 schematically illustrates a segmentation structure of a re-ordering buffer at 3.6 Mb/s UE class according to a second embodiment of the present invention.

### DETAILED DESCRIPTION OF THE PREFERRED EMBODIMENTS OF THE INVENTION

Although the present invention can be applied for any of the classes which UE supports, in order to explain the principle of the invention, the case of UE support of the 3.6 Mb/s class during communication in the WCDMA HSDPA system is used as an example. Therefore, the maximum length of TTI data is 7300 bits. TTI data, or MAC-hs PDU (protocal data unit), comprises a MAC-hs header, MAC-hs SDUs (Service Data Unit) and a Padding (optional). What needs to be stored in the re-ordering buffer is MAC-hs SDUs and Padding. Thus, the maximum data size stored in the buffer is 7296 bits.

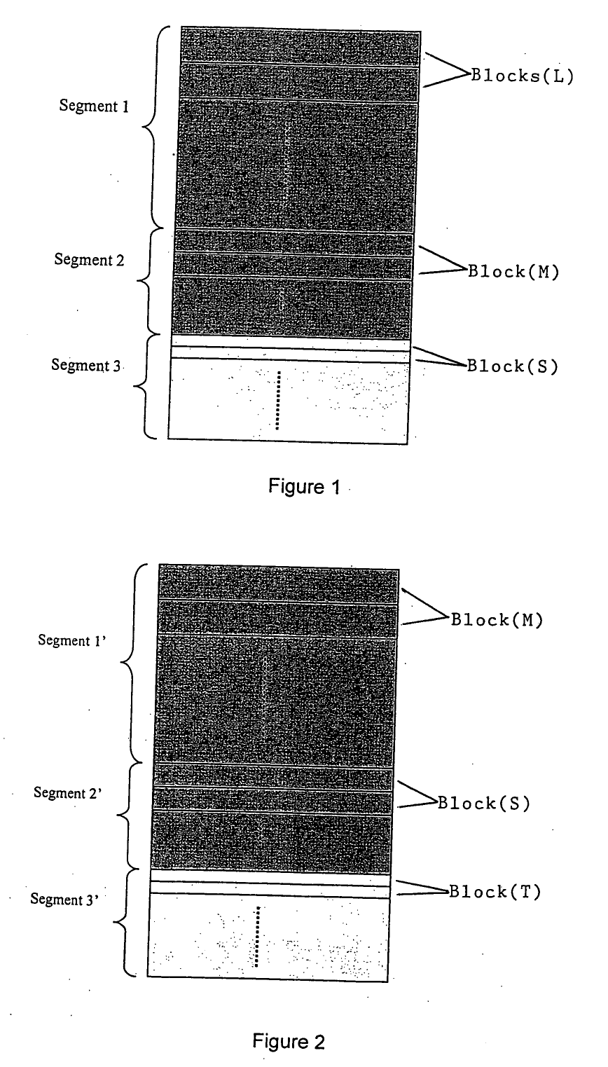

FIG. 1 schematically illustrates a segmentation structure of a re-ordering buffer at 3.6 Mb/s UE class according to a first embodiment of the present invention. Under ideal channel conditions, TTI data is transmitted at high speed, and if the network has enough code resource, large-sized TTI data is expected to be sent to the UE. However, even if the network does not have enough code resource for the UE, it is still possible to send medium to small-sized TTI data to the UE. The number of TTI data to be stored in re-ordering buffer will be very small as there are few re-transmissions needed. Taking the above into consideration, in the first embodiment, the re-ordering buffer is segmented into three segments, wherein each segment comprises multiple blocks with equal size. There is a close relationship among the sizes of the blocks of the three segments, namely, the size of the blocks of one segment is a multiple of the sizes of the blocks of the other segments. In the first embodiment, the size of the blocks of segment 1 is two times that of segment 2 and four times that of segment 3. Of course, any person skilled in the art can derive other variations, such as the size of the blocks of segment 1 can be three times of segment 2 and six times of segment 3, which falls within the scope of the invention.

Here, the blocks of segment 1 are referred as large blocks (L), those of segment 2 as medium blocks (M), and those of segment 3 as small blocks (S). Therefore, the sizes of the blocks of the three segments have the following relationship: 1*L=2*M=4*S, more specifically, the sizes of the blocks of segment 1, segment 2 and segment 3 can be 7296 bits, 3648 bits and 1824 bits, respectively.

Based on the segmentation structure of the re-ordering buffer according to the first embodiment, a rule for mapping one TTI data to the re-ordering buffer is defined as follows:

(1) Ranging the TTI data according to its size,

According to the method of the present embodiment, TTI data having a size of between 3649 bits and 7296 bits is ranged in the large category; TTI data having a size which is between 1825 bits and 3648 bits is ranged in the medium category; and TTI data having a size which is below 1824 bits is ranged in small category.

(2) Looking for one free block in a segment, the size of which matches that of TTI data to be buffered.

If the TTI data is ranged in the large category, then the matching block is a large block (L) in segment 1. If the TTI data is ranged in medium category, the matching block is a medium block (M) in segment 2. If the TTI data is ranged in small category, the matching block is a medium block (S) in segment 3.

(3) If (2) is unsuccessful, which means that all the matching blocks are full, then mapping the TTI data so that it shares a block with other data or occupies the fewest block(s) possible, more particularly,

(3-1) buffering large size TTI data,

(3-1-1) looking for two adjacent medium blocks in segment 2;

(3-1-2) if (3-1-1) is unavailable, looking for four adjacent small blocks in segment 3;

(3-2) buffering medium size TTI data,

(3-2-1) looking for a large block in segment 1 which is partially occupied, for example, occupied by another medium-size TTI data, and still has enough space for the TTI data;

(3-2-2) if (3-2-1) is unavailable, looking for a free large block in segment 1 and occupying half of the block;

(3-2-3) if (3-2-2) is unavailable, looking for two adjacent small blocks in segment 3.

(3-3) buffering small size TTI data,

(3-3-1) looking for a medium block in segment 2 which is partially occupied, i.e., occupied by another small-size TTI data, and still has enough space for the TTI data;

(3-3-2) if (3-3-1) is unavailable, looking for a free medium block in segment 2 and occupying half of the block;

(3-3-3) if (3-3-2) is unavailable, looking for a large block in segment 1 which is partially occupied and still has enough space for the TTI data, and occupying a front part of the space;

(3-3-4) if (3-3-3) is unavailable, looking for a free large block in segment 1 and occupying a first quarter of the block.

According to the specification, Joint RAN WG 1 and RAN WG 2 meeting on HSDPA technical document 12A010051 section 2.5.1, under ideal channel conditions, it is assumed that only one HARQ process, which is at the highest speed transmission, is active, and this is the maximum data size UE need to consider. Then, the re-ordering buffer size is calculated as N×16. Given that UE supports 3.6 Mbps class, the re-ordering buffer size is 7300×16 bits.

Given the above, according to the method proposed in the first embodiment, the re-ordering buffer will be segmented as follows:

Segment 1: 7296×8 bits

Segment 2: 3648×8 bits

Segment 3: 1824×16 bits.

Using the mapping rules disclosed in this embodiment, the re-ordering buffer can buffer a total of 16 large TTI data, 32 medium TTI data, or 64 small TTI data, which is within the UE capability defined in the 3GPP specification.

With respect to FIG. 2, the second embodiment of the invention will be explained.

In the second embodiment, a variation of the first embodiment is considered. In practice, under bad channel conditions, medium to small TTI data is expected to be sent to the UE even if network has the code resource. And the number of TTI data to be stored in the re-ordering buffer will be a little larger, since a few re-transmissions are possible. Taking the above into consideration, in the second embodiment, the re-ordering buffer is segmented into three segments, wherein each segment comprises multiple blocks with equal size. There is close relationship among the sizes of the blocks of the three segments, namely, the sizes of the blocks of the three segments are multiple-related. In the second embodiment, the size of the blocks of segment 1′ is two times of segment 2′ and four times of segment 3′.

Here, the blocks of segment 1′ are referred as medium blocks (M), those of segment 2′ as small blocks (S), and those of segment 3′ as tiny blocks (T). Therefore, the sizes of the blocks of the three segments have the following relationship: 1*M=2*S=4*T, more specifically, the sizes of the blocks of segment 1′, segment 2′ and segment 3′ can be 3648 bits, 1824 bits and 912 bits, respectively. Here, M and S are the same sizes as in the first embodiment. Using the definition of large block in the first embodiment, we can have following full relationship in terms of block size, 1*L=2*M=4*S=8*T.

Based on the segmentation structure of the re-ordering buffer according to the second embodiment, a rule for mapping one TTI data to the re-ordering buffer is defined as follows:

(1′) Ranging the TTI data according to its size,

According to the method of the present embodiment, the TTI data having a size of between 3649 bits and 7296 bits is ranged in large category; the TTI data having a size of between 1825 bits and 3648 bits is ranged in medium category; the TTI data having a size of between 912 and 1824 bits is ranged in small category; and the TTI data having a size of below 912 bits is ranged in tiny category.

(2′) If the TTI data to be buffered large in size, looking for two adjacent blocks in segment 1′; if not available, looking for four adjacent small blocks in segment 2′; if still not available, looking for eight adjacent tiny blocks in segment 3′.

(3′) If the TTI data to be buffered is in another category (medium, small or tiny), looking for one free block in a segment, the size of which matches that of TTI data to be buffered.

If the TTI data is ranged in the medium category, then the matching block is a medium block (M) in segment 1′. If the TTI data is ranged in small category, the matching block is a small block (S) in segment 2′. If the TTI data is ranged in tiny category, the matching block is a tiny block (T) in segment 3′.

(4′) If (3′) is unsuccessful, which means that all the matching blocks are full, then mapping the TTI data so that it shares a block with other data or occupies as less block(s) as possible, more particularly,

(4′-1) for the TTI data to be buffered is medium size,

(4′-1-1) looking for two adjacent small blocks in segment 2′;

(4′-1-2) if (4′-1-1) is unavailable, looking for four adjacent tiny blocks in segment 3′;

(4′-2) when the TTI data to be buffered is small size,

(4′-2-1) looking for a medium block in segment 1′ which is partially occupied, for example, occupied by another small-size TTI data, and which still has enough space for the TTI data;

(4′-2-2) if (4′-2-1) is unavailable, looking for a free medium block in segment 1′ and occupying half of the block;

(4′-2-3) if (4′-2-2) is unavailable, looking for two adjacent tiny blocks in segment 3′.

(4′-3) when the TTI data to be buffered is tiny size,

(4′-3-1) looking for a small block in segment 2′ which is partially occupied, i.e., occupied by another tiny-size TTI data, and still has enough space for the TTI data;

(4′-3-2) if (4′-3-1) is unavailable, looking for a free small block in segment 2′ and occupying half of the block;

(4′-3-3) if (4′-3-2) is unavailable, looking for a medium block in segment 1′ which is partially occupied and still has enough space for the TTI data, and occupying a front part of the space;

(4′-3-4) if (4′-3-3) is unavailable, looking for a free medium block in segment 1 and occupying a first quarter of the block.

Given that the buffer size is 7300×16 bits as specified in the above-mentioned specification, according to the method proposed in the first embodiment, the re-ordering buffer will be segmented as follows:

Segment 1′: 3648×16 bits

Segment 2′: 1824×16 bits

Segment 3′: 912×32 bits.

Using the mapping rules disclosed in this embodiment, the re-ordering buffer can buffer 16 large TTI data, 32 medium TTI data, 64 small TTI data, or 128 tiny TTI data, in compliance with the re-ordering buffer specification requirements under bad channel conditions.

Under worse channel conditions, only small TTI data is expected to be sent to UE, and the number of TTI data stored in the re-ordering buffer is large, since all of the active re-ordering queues may need re-transmission at the same time. To achieve better performance without increasing the algorithm complexity, additional buffer size is considered. However, the method of segmenting and mapping remains the same as the first and second embodiments. The additional buffer size, ranging from 20%-25% of the re-ordering buffer size, will not introduce trade-off protocol performance.

### ADVANTAGE OF THE INVENTION

Compared with the prior static algorithm, the method of segmenting and mapping of the present invention can store more TTI data. Taking the re-ordering buffer size of 7300×16 bits as an example, using the static algorithm, only 16 TTI data, no matter large, medium, small or tiny size, can be stored, while the re-ordering buffer of the present buffer can store 16 large, 32 medium, 64 small or 128 tiny TTI data.

Compared with the prior dynamic algorithm, the method of the present invention is easier and faster, since it does not need garbage collection, which reqires a long processing time.

In view of the description of the invention included herein, numerous additional embodiments and variations on the discussed embodiments of the present invention will be apparent to one of ordinary skill in the art. It is to be understood that such embodiments do not depart from the present invention and are to be considered within the scope of the invention.

1. A method of segmenting a re-ordering buffer in WCDMA HSDPA system, comprising the steps of:
dividing the re-ordering buffer into multiple segments;
dividing each segment into multiple blocks such that blocks within the same segment have the same size while the sizes of blocks located in separate segments are integer multiples of each other.

2. A method according to claim 1, wherein the multiple segments include a first, second and third segment.

3. A method according to claim 2, wherein the size of the blocks of the first segment is 2 times that of the second segment, and 4 times that of the third segment.

4. A method according to claim 3, wherein the size of the blocks of the first segment is the maximum length of received TTI data.

5. A method according to claim 3, wherein the size of the blocks of the first segment is half of the maximum length of received TTI data.

6. A re-ordering buffer for storing TTI data in WCDMA HSDPA system, comprising multiple segments, wherein each segment is composed of multiple blocks with equal size, and the sizes of the blocks of a first segment of the multiple segments are integer multiples of the sizes of the blocks of additional segments of the multiple segments.

7. A method of mapping TTI data to the re-ordering buffer of claim 6, comprising the steps of:
determining a size category of the TTI data;
comparing the size category of the TTI data with sizes of the blocks of the first segment and the additional segments to find a matching block for storing the TTI data;
storing the TTI data in the matching block if an empty matching block is found, but if no empty matching block is found then:
storing the TTI data in a block with a size larger than the size category of the TTI data;
storing the TTI data in adjacent blocks, if such a block with a larger size is unavailable.

8. A method according to claim 7, wherein the step of determining is based on the size of the TTI data and the sizes of the blocks of the segments.

9. A method according to claim 7, wherein the step of storing the TTI data in a block with a larger size comprises the steps of:
If a larger sized block is partially occupied but still has enough space for the TTI data, storing the data in the block; and
If such a larger sized block is unavailable, storing the TTI data in a free block with a larger size.

10. A method according to claim 7, wherein the step of storing the TTI data in adjacent blocks comprises a step of storing the TTI data in a minimum number of adjacent blocks.
